(19) United States
(12) Patent Application Publication
(10) Pub. No.: US 2026/0031850 A1
(43) Pub. Date: Jan. 29, 2026

(54) SYSTEMS, METHODS, AND DEVICES FOR INTERFERENCE CANCELLATION IN WIRELESS DEVICES

(71) Applicant: Cypress Semiconductor Corporation, San Jose, CA (US)

(72) Inventors: Suprojit Mukherjee, Nadia (IN); Ayush Sood, Bengaluru (IN); Kiran Uln, Pleasanton, CA (US); Ravi Gupta, Sunnyvale, CA (US); J. L. Julian Tham, Sunnyvale, CA (US)

(73) Assignee: Cypress Semiconductor Corporation, San Jose, CA (US)

(21) Appl. No.: 18/787,613

(22) Filed: Jul. 29, 2024

(51) Int. Cl. H04B 1/525; H04B 1/16

(52) U.S. Cl. CPC H04B 1/525; H04B 1/1607

(57) ABSTRACT

Systems, methods, and devices perform interference cancellation operations for wireless devices. Methods include transmitting an input signal using a transmitter of a transceiver included in a wireless device, receiving an interference signal at a receiver of the transceiver, wherein the interference signal is a leakage signal, and performing interference cancellation operations on the interference signal based, at least in part, on one or more adjustments to the receiver determined based on the input signal and the received interference signal. Methods further include generating, using the transceiver, an output signal based, at least in part, on the interference cancellation operations.

### TECHNICAL FIELD

This disclosure relates to wireless devices, and more specifically, to enhancement of interference cancellation for such wireless devices.

### BACKGROUND

Wireless devices may include transceivers configured to generate and receive wireless signals in accordance with one or more wireless communications protocols. Accordingly, such transceivers may include transmit chains and receive chains configured to implement transmit operations and receive operations, respectively. Conventional wireless devices remain limited because the transmit chains and receive chains might not be entirely isolated, and leakage from the transmit chain may affect signals received at the receive chain.

### BRIEF DESCRIPTION OF THE DRAWINGS

FIG. 1 illustrates an example of a wireless system, configured in accordance with some embodiments.

FIG. 2 illustrates an example of a wireless device, configured in accordance with some embodiments.

FIG. 3 illustrates an example of a wireless device configured to perform interference cancellation operations in accordance with some embodiments.

FIG. 4 illustrates another example of a wireless device configured to perform interference cancellation operations in accordance with some embodiments.

FIG. 5 illustrates an additional example of a wireless device configured to perform interference cancellation operations in accordance with some embodiments.

FIG. 6 illustrates another example of a wireless device configured to perform interference cancellation operations in accordance with some embodiments.

FIG. 7 illustrates an example of a method for interference cancellation, performed in accordance with some embodiments.

FIG. 8 illustrates another example of a method for interference cancellation, performed in accordance with some embodiments.

FIG. 9 illustrates an additional example of a method for interference cancellation, performed in accordance with some embodiments.

FIG. 10 illustrates another example of a method for interference cancellation, performed in accordance with some embodiments.

FIG. 11 illustrates an additional example of a method for interference cancellation, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may include transceivers that include components configured to perform transmit and receive operations for wireless communications. For example, a transceiver may include a transmit chain of components that generate a signal provided to an antenna for transmission, and also include a receive chain of components that receive a signal via the antenna. In some embodiments, wireless devices may toggle between a wireless communications mode and a radar mode. When in a wireless communications mode, the transceiver may be configured to transmit and receive data packets in accordance with a wireless communications protocol, such as a Wi-Fi protocol. When in a radar mode, the transceiver may be reconfigured to perform radar operations based on transmission of signals and reception of reflected signals during the radar mode.

Proximity between the transmit and receive components as well as sharing of an antenna may result in interference between the transmit chain and the receive chain. For example, a leakage current or signal may originate from the transmit chain and be received at the receive chain as signal interference. Such interference may be problematic and interfere with accuracy of radar detection operations.

Accordingly, embodiments disclosed herein provide techniques for reducing and/or eliminating such interference components. As will be discussed in greater detail below, several different interference cancellation operations may be performed sequentially and dynamically to reduce an amount of interference experienced by a receive chain of the transceiver. For example, course adjustments may be implemented using voltage attenuators and phase shifters. Moreover, fine adjustments may be implemented via one or more adaptive filters. Furthermore, usage of such voltage attenuators, phase shifters, and adaptive filters may be configured dynamically and in response to determinations as to whether or not such interference cancellation operations should be performed. In this way, sequential interference cancellation operations may be performed at different locations along the receive chain to improve the accuracy and efficacy of interference mitigation, and selection of such interference cancellation operations may be implemented dynamically such that interference cancellation operations are performed efficiently, and as needed.

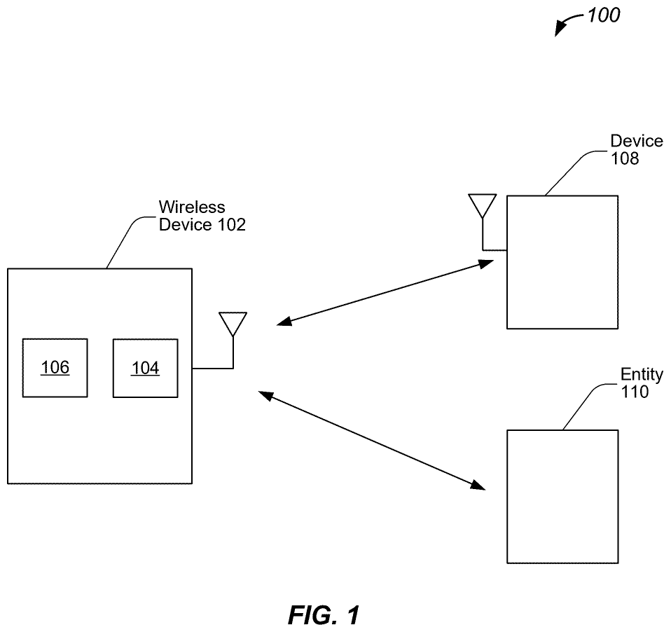

FIG. 1 illustrates an example of a wireless system, configured in accordance with some embodiments. Accordingly, a system, such as system 100, may include wireless devices that are used for wireless communications, and are also configured as a radar device being able to detect the presence of objects using wireless communications channels associated with such wireless devices. As will be discussed in greater detail below, wireless devices included in system 100 may be configured to reduce leakage currents that may otherwise affect such presence detection operations, thus improving the efficacy and accuracy of such presence detection operations.

In some embodiments, system 100 includes wireless device 102 which is configured to transmit and receive wireless signals in accordance with one or more communications protocols. For example, wireless device 102 may include one or more transceivers, such as transceiver 104, which is configured to transmit and receive signals in accordance with a wireless communications protocol, such as a Wi-Fi protocol. In various embodiments, wireless device 102 additionally includes a processing device, such as processing device 106, which is configured to implement various hardware and logic associated with transceiver 104, and its associated wireless communications protocol. For example, processing device 106 may be configured to implement a medium access control (MAC) layer that is configured to control hardware associated with a wireless transmission medium, such as that associated with a Wi-Fi transmission medium.

In various embodiments, wireless device 102 is within communications range of one or more devices or entities. In one example, wireless device 102 is within range of device 108, which may be another wireless device. Accordingly, device 108 may also include a transceiver and associated processing logic configured to facilitate wireless communications in accordance with a wireless communications protocol, such as a Wi-Fi protocol. Thus, wireless device 102 may be configured to establish a wireless connection with device 108, and transmit and receive data packets to and from device 108. In one example, wireless device 102 may be configured as a central device, such as an access point (AP), and device 108 may be configured as a peripheral device, such as a station (STA).

Moreover, wireless device 102 is also in range of entity 110. In various embodiments, entity 110 may be an object or a person within range of wireless device 102 and the target of radar ranging operations when wireless device 102 is in a radar mode. As will be discussed in greater detail below, wireless device 102 is configured to identify the presence of entity 110 based on radar operations performed using wireless communications channels that may also be used to communicate with devices, such as device 108. In this way, system 100 may support wireless communication as well as presence detection associated with entities, such as objects and humans within range of wireless device 102.

Moreover, as will also be discussed in greater detail below, components of wireless device 102 are configured to reduce interference experienced during such presence detection operations. For example, calibration operations may be performed to identify components of a leakage signal, and selectively cancel them thus removing such leakage signal components from a received signal at transceiver 104. Additional details regarding such leakage signals and calibration operations are discussed in greater detail below.

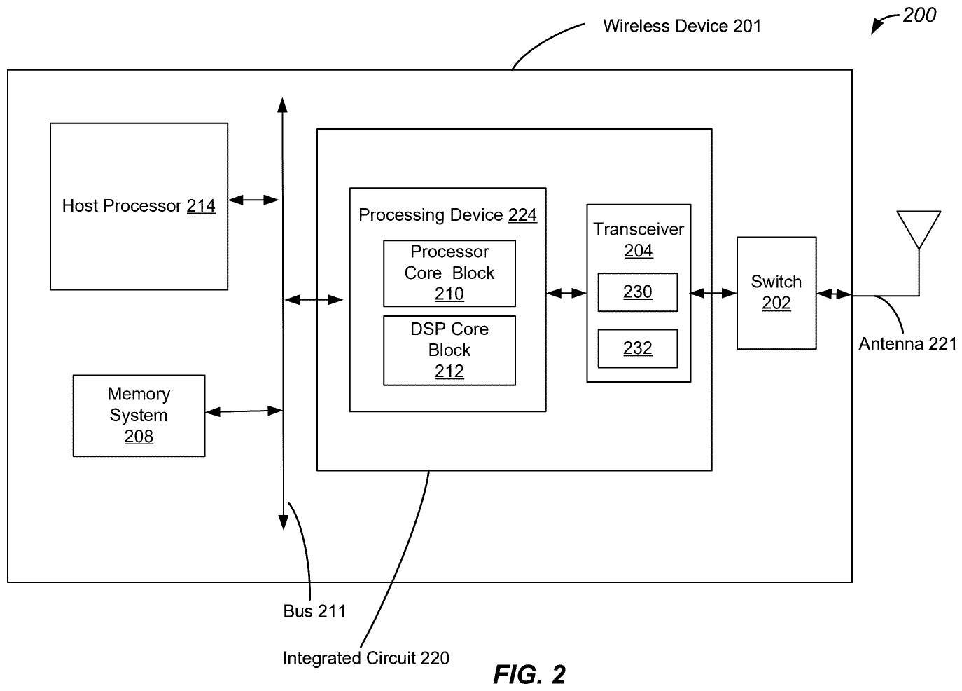

FIG. 2 illustrates an example of a wireless device, configured in accordance with some embodiments. More specifically, FIG. 2 illustrates an example of a system, such as system 200, that may include wireless device 201. It will be appreciated that wireless device 201 may be one of any of the wireless devices discussed above with reference to FIG. 1, such as wireless device 102 and device 108.

In various embodiments, wireless device 201 includes one or more transceivers, such as transceiver 204. In one example, system 200 includes transceiver 204 which is configured to transmit and receive signals using an antenna, such as antenna 221. As noted above, transceiver 204 may be a Wi-Fi transceiver. Accordingly, transceiver 204 may be compatible with a wireless communications protocols, such as a Wi-Fi protocol. In various embodiments, transceiver 204 includes a modulator and demodulator as well as one or more buffers and filters, that are configured to generate and receive signals via antenna 221. Accordingly, as will be discussed in greater detail below, transceiver 204 may include chains of components configured to perform such operations, such as a transmit chain and a receive chain. Each of the transmit chain and receive chain may be included in a transmitter and receiver respectively, such as transmitter 230 and receiver 232. Moreover, as will also be discussed in greater detail below, transceiver 204 and switch 202 may be configured to perform interference cancellation operations to cancel components of a leakage signal that might otherwise occur within transceiver 204.

In various embodiments, system 200 further includes one or more processing devices, such as processing device 224 which may include logic implemented using one or more processor cores. Accordingly, processing device 224 is configured to implement logic for presence detection operations. For example, processing device 224 may be configured to use wireless connection metrics and other channel information to infer the presence of one or more entities within a wireless communications range of wireless device 201. Accordingly, processing device 224 may be configured to perform radar operations and presence determination operations when configured in a radar mode. In one example, toggling between a communications mode and a radar mode may be implemented via logic implemented in firmware. Accordingly, processing device 224 includes processing elements, that may be implemented in firmware, configured to perform wireless communication operations in which data packets are transmitted and received, may also be configured to perform presence detection operations, as well as operations to switch between the two. It will be appreciated that the radar operations and computations may be any suitable radar computation technique using frequency and phase measurements and data as well as other available signal metrics.

Processing device 224 includes one or more components configured to implement a media access control (MAC) layer that is configured to control hardware associated with a wireless transmission medium, such as that associated with a Wi-Fi transmission medium. In one example, processing device 224 may be configured to implement a driver, such as a Wi-Fi driver. Accordingly, processing device 224 may include components associated with transceiver 204, such as MAC layers, packet traffic arbiters, and a scheduler. In various embodiments, processing device 224 includes processing blocks, such as processor core block 210 and DSP core block 212, to implement these features. In various embodiments, the scheduler may also be configured to switch between a data communication mode and a radar mode, thus enabling different configuration(s) of various cancelation blocks.

System 200 further includes switch 202 which is coupled to antenna 221. In various embodiments, switch 202 may include various components such as a radio frequency (RF) switch, a diplexer, and a filter. Accordingly, switch 202 may be configured to select a transmit chain or a receive chain to be coupled antenna 221 for transmission/reception. As will be discussed in greater detail below, switch 202 may also be configured to be coupled to an electrical termination during some interference cancellation operations. Terminating switch 202 in this way may improve an accuracy of such interference cancellation operations. In some embodiments, electrical termination may include coupling the switch to an electrical ground, or simply leaving the switch in an open or floating state.

System 200 includes memory system 208 which is configured to store one or more data values associated with interference cancellation operations discussed in greater detail below. Accordingly, memory system 208 includes storage device, which may be a non-volatile random-access memory (NVRAM) configured to store such data values, and may also include a cache that is configured to provide a local cache. In various embodiments, system 200 further includes host processor 214 which is configured to implement processing operations implemented by system 200.

It will be appreciated that one or more of the above-described components may be implemented on a single integrated circuit, or on different integrated circuits. For example, transceiver 204 and processing device 224 may be implemented in the same integrated circuit, such as integrated circuit 220. In another example transceiver 204 and processing device 224 may each be implemented in their own integrated circuit, and thus may be disposed separately as a multi-chip module or on a common substrate such as a printed circuit board (PCB). It will also be appreciated that components of system 200 may be implemented in a variety of contexts, such as the context of a smart home environment, an automotive environment, or a wireless environment including Internet of Things (IoT) devices.

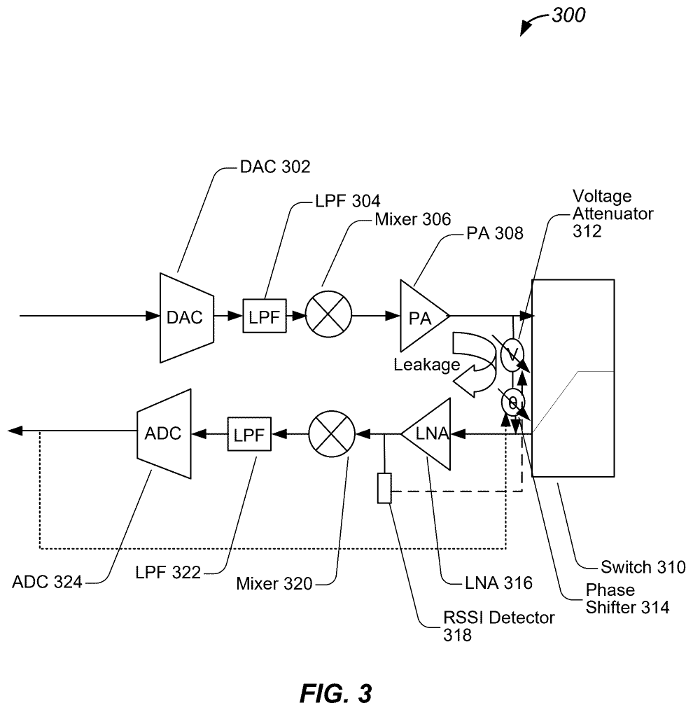

FIG. 3 illustrates an example of a wireless device configured to perform interference cancellation operations in accordance with some embodiments. As similarly discussed above, various calibration operations may be performed to cancel interference that may otherwise occur between transmit and receive components of a transceiver. For example, a wireless device, such as wireless device 300, may include various components configured to transmit and receive signals via an antenna. As will be discussed in greater detail below, one or more components of wireless device 300 may be configured to cancel voltage and phase components of a leakage signal that may otherwise be received by the receive components of the transceiver.

As shown in FIG. 3, a transceiver of wireless device 300 may include components of a transmit chain, such as digital-to-analog converter (DAC) 302, low pass filter (LPF) 304, mixer 306, and power amplifier (PA) 308. In various embodiments, a digital input is provided to DAC 302 from one or more other components of wireless device 300, such as a processing device configured to generate digital signals for transmission. In various embodiments, the input signal may be an arbitrary waveform generated for calibration operations. For example, the input signal may include a test pattern defined by an entity, such as a manufacturer.

Wireless device 300 may also include components of a receive chain, such as low-noise amplifier (LNA) 316, mixer 320, LPF 322, and analog-to-digital converter (ADC) 324. Accordingly, a signal may be received from an antenna coupled to switch 310, and the received signal may be provided as an output via ADC 324. As discussed above, during operation, a leakage signal may be received at the receive chain based on activity of the transmit chain. Accordingly, as will be discussed in greater detail below, wireless device 300 may include voltage attenuator 312 and phase shifter 314 which are configured to mitigate components of the leakage signal.

In various embodiments, wireless device 300 further includes receive signal strength indicator (RSSI) detector 318 which is configured to detect an analog signal output by LNA 316 and convert the detected analog signal to discrete levels. Accordingly, RSSI detector 318 may include a small resolution DAC that is configured to generate an output signal having discrete levels corresponding to the received input. In various embodiments, an output of RSSI detector 318 is provided to voltage attenuator 312 and is configured to control an operation of voltage attenuator 312. More specifically, a look-up-table may be used to map the discrete levels to voltage adjustments. As will be discussed in greater detail below, voltage attenuator 312 may be adjusted until the detected signal from LNA 316 drops below a designated threshold value which may be determined by an entity, such as a manufacturer. The designated threshold may represent an acceptable amplitude of a leakage signal.

In various embodiments, an output of ADC 324 may be provided to phase shifter 314, and an output of ADC may be mapped to phase adjustments applied to phase shifter 314. In various embodiments, adjustments for voltage attenuator 312 and phase shifter 314 may be determined based on an exhaustive search or a steepest descent algorithm to identify a configuration and adjustment that achieves the best cancellation. Accordingly, during a calibration process, voltage attenuator 312 and phase shifter 314 may be configured to cancel and mitigate components of a leakage signal. As will be discussed in greater detail below, additional interference cancellation operations may be performed further downstream in the receive chain to further refine interference cancellation of the leakage signal.

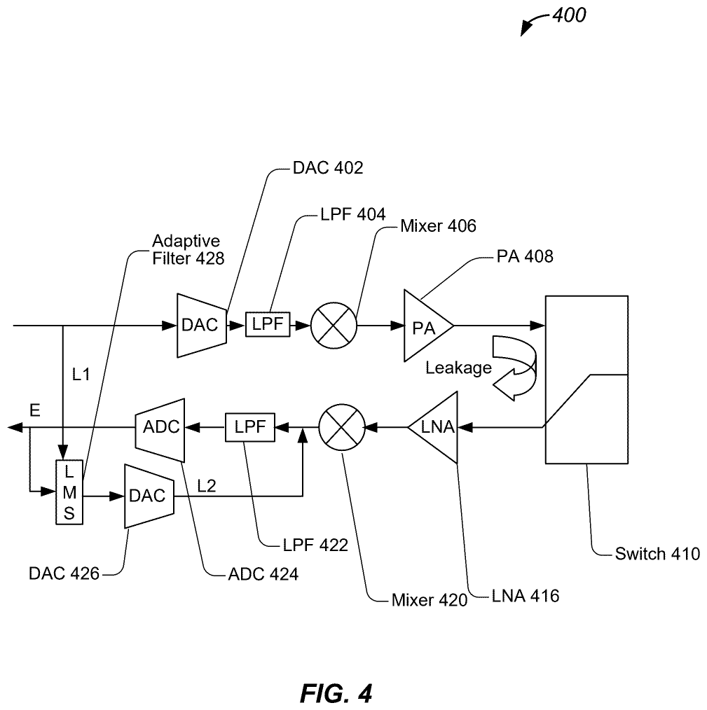

FIG. 4 illustrates another example of a wireless device configured to perform interference cancellation operations in accordance with some embodiments. As similarly discussed above, a wireless device, such as wireless device 400, may include components of a transmit chain, such as DAC 402, LPF 404, mixer 406, and power amplifier (PA) 408. Wireless device 400 may also include components of a receive chain, such as LNA 416, mixer 420, LPF 422, and ADC 424. Wireless device 400 may additionally include switch 410 configured to manage coupling with an antenna.

In various embodiments, wireless device 400 additionally includes adaptive filter 428 and DAC 426 which are configured to perform additional interference cancellation operations. More specifically, adaptive filter 428 is configured to receive an output of ADC 424 which, during the calibration phase and in response to a training signal being input to DAC 402, may also provide an error signal for interference cancellation. Moreover, adaptive filter 428 may also receive the input training signal that is provided to DAC 402. Adaptive filter 428 may be configured to apply one or more parameter estimation techniques, such as a least mean square equation that has several weights within a least mean square equation. In various embodiments, the weights may be changed iteratively until the weights converge. Moreover, the weights may be determined based on a least mean squares (LMS) or recursive least squares (RLS) algorithm having a step size configured to implement gear-shifting to facilitate fast convergence and a small mean square error. An example of relationships between parameters and adjustment of weights is described below with reference to equations 1-4 shown below:

$$Y = L + N \qquad ( 1 )$$

$$E = L 2 - Y \qquad ( 2 )$$

$$W = W + k * E * Y \qquad ( 3 )$$

$$L 2 = {W}^{T} * L 1 \qquad ( 4 )$$

In various embodiments, L is a leakage signal, N is a noise figure, and Y is a received signal including both. Moreover, E is an error signal, L1 is the input training signal, and L2 is an output of adaptive filter 428 and DAC 426. Moreover, W represents a weight and k is a scaling factor. As discussed above, W may be iteratively adjusted until an amplitude of E falls below a designated threshold value. In this way, adaptive filter 428 and DAC 426 may be configured during a calibration process, and their output may be made available for normal operation of wireless device 400. As shown in FIG. 4, the output of DAC 426 may be provided at a point upstream of LPF 422. Accordingly, wireless device 400 may be configured such that calibration operations are performed before LPF 422, and are not subject to band limitations of LPF 422. When performed in this way, such calibration operations may be performed while avoiding saturation of LPF 422. As will be discussed in greater detail below, switch 410 may be configured to be coupled to a circuit ground during calibration operations.

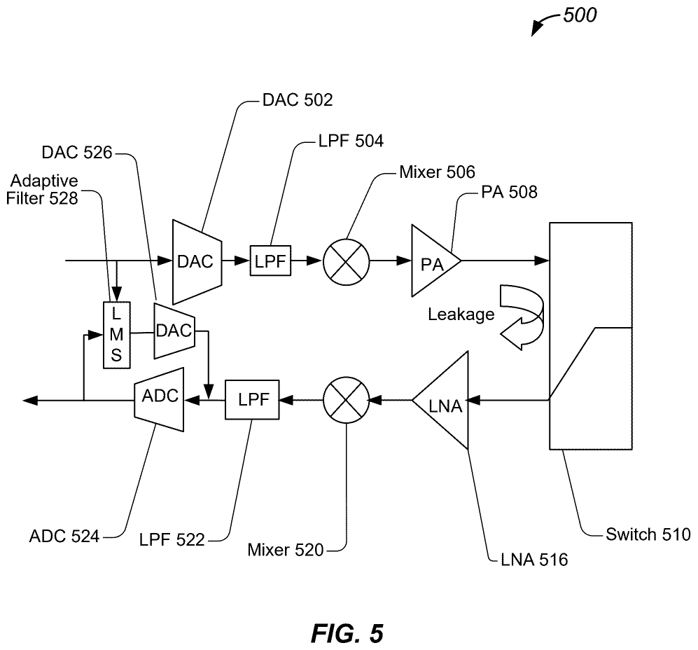

FIG. 5 illustrates an additional example of a wireless device configured to perform interference cancellation operations in accordance with some embodiments. As similarly discussed above, a wireless device, such as wireless device 500, may include components of a transmit chain, such as DAC 502, LPF 505, mixer 506, and power amplifier (PA) 508. Wireless device 500 may also include components of a receive chain, such as LNA 516, mixer 520, LPF 522, and ADC 525. Wireless device 500 may additionally include switch 510 configured to manage coupling with an antenna.

In various embodiments, wireless device 500 additionally includes adaptive filter 528 and DAC 526 which are configured to perform additional interference cancellation operations. As similarly discussed above, adaptive filter 528 is configured to receive an output of ADC 524 which, during the calibration phase and in response to a training signal being input to DAC 502, may also provide an error signal for interference cancellation. Moreover, adaptive filter 528 may also receive the input training signal that is provided to DAC 502. As also discussed above, adaptive filter 528 may be configured to apply one or more parameter estimation techniques, such as a least mean square equation that has several weights within a least mean square equation. In various embodiments, the weights may be changed iteratively until the weights converge. As discussed above, the weights may be iteratively adjusted until an amplitude of the error signal, which may be the output of ADC 524, falls below a designated threshold value.

As shown in FIG. 5, the output of DAC 526 may be provided at a point downstream of LPF 522. Accordingly, wireless device 500 may be configured such that calibration operations are performed after LPF 522, and may provide additional fine tuning of calibration operations. In various embodiments, a cancellation in the analog domain before ADC 524 improves dynamic range and a signal to noise ratio (SNR) of the output signal. In one example, cancellation in the digital domain may improve accuracy as adaptive filter 528 may target a smaller mean square error. As will be discussed in greater detail below, switch 510 may be configured to be coupled to a suitable termination during calibration operations.

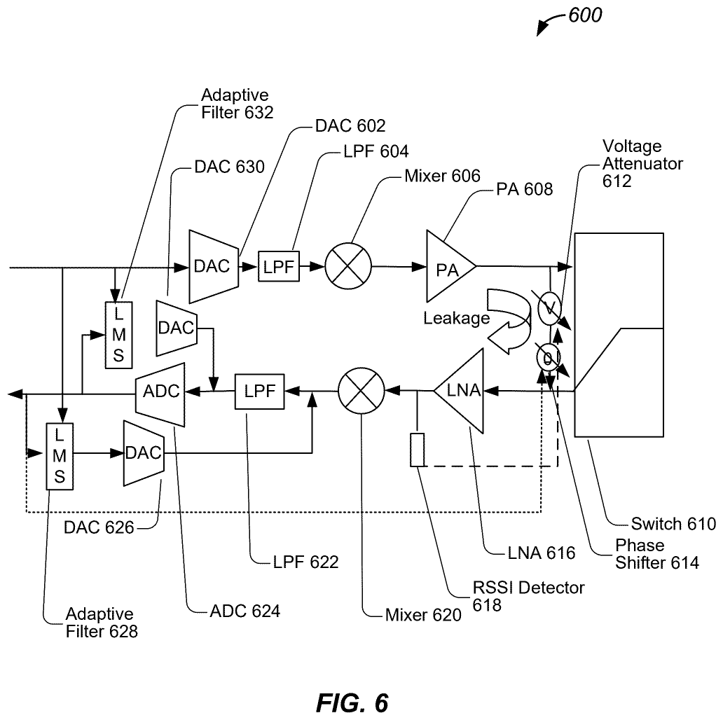

FIG. 6 illustrates another example of a wireless device configured to perform interference cancellation operations in accordance with some embodiments. Moreover, FIG. 6 illustrates multiple interference cancellation operations implemented in a combined manner. As similarly discussed above, a wireless device, such as wireless device 600, may include components of a transmit chain, such as DAC 602, LPF 604, mixer 606, and power amplifier (PA) 608. Wireless device 600 may also include components of a receive chain, such as LNA 616, mixer 620, LPF 622, and ADC 624. Wireless device 600 may additionally include switch 610 configured to manage coupling with an antenna.

In various embodiments, wireless device 600 additionally includes voltage attenuator 612, phase shifter 614, and RSSI detector 618 which may be configured to perform first interference cancellation operations, as similarly discussed above. Accordingly, voltage attenuator 612, phase shifter 614, and RSSI detector 618 may be configured to phase and voltage adjustments to reduce components of a leakage signal during first interference cancellation operations.

Wireless device 600 may further include adaptive filter 628 and DAC 626 which are configured to implement parameter estimation techniques to perform second interference cancellation operations. As similarly discussed above, iterative adjustments may be made to weights in a least mean square equation of adaptive filter 628 to further reduce components of the leakage signal during the second interference cancellation operations. Moreover, as also discussed above, such second interference cancellation operations may be performed with coupling provided upstream of LPF 622.

Wireless device 600 may additionally include adaptive filter 632 and DAC 630 which are also configured to implement parameter estimation techniques to perform third interference cancellation operations. As similarly discussed above, iterative adjustments may be made to weights in a least mean square equation of adaptive filter 632 to further reduce components of the leakage signal during the third interference cancellation operations. Moreover, as also discussed above, such third interference cancellation operations may be performed with coupling provided downstream of LPF 622. In this way, multiple stages of interference cancellation operations may be implemented and combined as part of an overall calibration process.

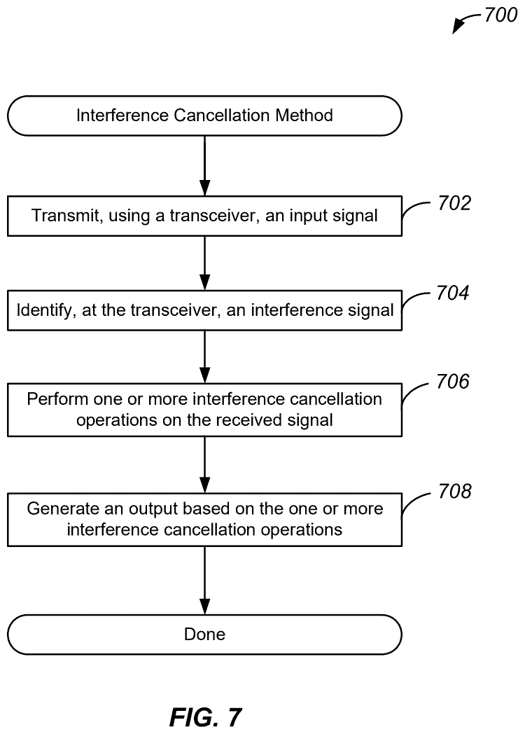

FIG. 7 illustrates an example of a method for interference cancellation, performed in accordance with some embodiments. As similarly discussed above, various interference cancellation operations may be performed to mitigate interference that may result from, for example, leakage between a transmit chain and a receive chain. Accordingly, a method, such as method 700, may be performed to implement interference cancellation operations to mitigate and reduce such interference.

Method 700 may perform operation 702 during which an input signal may be transmitted. As similarly discussed above, the input signal may be a designated signal, such as a training signal, generated and transmitted via a transmit chain of a transceiver during a calibration phase. Accordingly, the training signal may have a known data pattern as well as one or more transmission parameters configured to emulate signals used during radar detection operations.

Method 700 may perform operation 704 during which an interference signal maybe identified. As also discussed above, a component coupled to a receive chain of the transceiver may detect a signal received at the receive chain as a result of the transmitting. For example, interference may occur at the receive chain as a result of transmission activity on the transmit chain. In one example, the interference may be leakage between the transmit chain and the receive chain that allows a leakage signal to be received at the receive chain while the transmit chain is transmitting the input signal. In various embodiments, the interference signal may be identified by a component, such as an RSSI detector.

Method 700 may perform operation 706 during which one or more interference cancellation operations may be performed. As similarly discussed above and as will be discussed in greater detail below, one or more interference cancellation operations may be performed during a calibration phase. As discussed above and as will be discussed in greater detail below, the interference cancellation operations may be performed at various different stages of the receive chain, and may include adjustments to components, such as voltage attenuators, phase shifters, and adaptive filters, to mitigate the interference signal.

Method 700 may perform operation 708 during which an output may be generated based on the one or more interference cancellation operations. Accordingly, once the calibration phase is complete, the transceiver may return to radar operation. Based on the previously described calibrations, the receive chain may receive a radar signal, mitigate interference that may occur due to leakage, and generate an output representing the received signal.

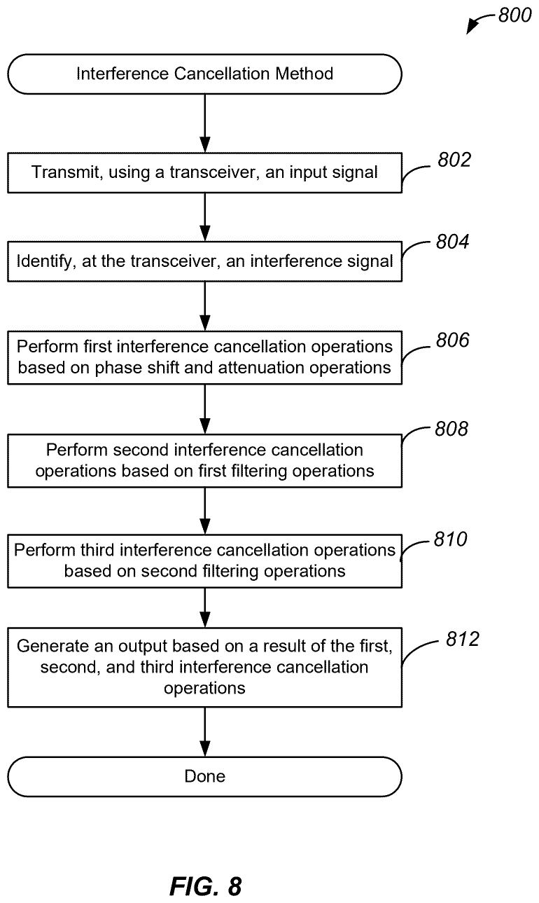

FIG. 8 illustrates another example of a method for interference cancellation, performed in accordance with some embodiments. As similarly discussed above, interference cancellation operations may be performed to mitigate interference that may result from leakage between a transmit chain and a receive chain. As will be discussed in greater detail below, a method, such as method 800, may be performed to implement multiple stages of interference cancellation operations to calibrate a transceiver and improve an efficacy of interference mitigation and cancellation during radar operation of the transceiver.

Method 800 may perform operation 802 during which an input signal may be transmitted. In various embodiments, the input signal is a designated signal, such as a training signal, generated and transmitted via a transmit chain of a transceiver during a calibration phase. Accordingly, the training signal may have a known data pattern as well as one or more transmission parameters configured to emulate signals used during radar detection operations.

As similarly discussed above, the transceiver may be a wireless communications transceiver. Accordingly, the transceiver and associated processing logic may switch from a communications mode to a radar mode, and may begin a calibration phase to calibrate the transceiver. For example, once switched to the radar mode, transmission of the training or test signal may begin. In various embodiments, such switching of modes may be managed by firmware included in a processing device, as similarly discussed above.

Method 800 may perform operation 804 during which an interference signal maybe identified. As also discussed above, a component coupled to a receive chain of the transceiver may detect a signal received at the receive chain, and the signal may be interference resulting from transmission activity on the transmit chain. In one example, the interference may be leakage between the transmit chain and the receive chain that allows a leakage signal to be received at the receive chain while the transmit chain is transmitting the input signal.

In various embodiments, the interference signal may be identified by a component, such as an RSSI detector. Moreover, during operation 804, the RSSI detector may convert the detected signal, which may be detected at an output of an LNA included in the receive chain, to one or more discrete voltage levels for use by one or more other components, such as a voltage attenuator.

Method 800 may perform operation 806 during which first interference cancellation operations may be performed based on phase shift and attenuation operations. Accordingly, as discussed above a voltage attenuator and a phase shifter coupled between the transmit chain and the receive chain may be configured based on the output of the RSSI detector as well as an output of the receive chain. More specifically, adjustments may be made to the voltage attenuator and the phase shifter until the output of the receive chain falls below a first designated threshold amplitude and/or an output of the LNA falls below a detection threshold of the RSSI detector.

Method 800 may perform operation 808 during which second interference cancellation operations may be performed based on first filtering operations. As similarly discussed above, the second interference cancellation operations may include use of a first adaptive filter prior to an LPF included in the receive chain. Accordingly, one or more weights of the first adaptive filter may be adjusted until the output of the receive chain falls below a second designated threshold amplitude.

It will be appreciated that the second interference cancellation operations may be performed dynamically and in response to interference signal detection after the first cancellation operations. For example, if an output of the receive chain continues to include interference exceeding a permissible threshold value after the first cancellation operations, the second interference cancellation operations may be performed. In this example, the permissible threshold value may be determined by an entity, such as a manufacturer or user, and may represent an overall permissible limit for signal interference.

Method 800 may perform operation 810 during which third interference cancellation operations may be performed based on second filtering operations. As similarly discussed above, the third interference cancellation operations may include use of a second adaptive filter after the LPF included in the receive chain. Accordingly, one or more weights of the second adaptive filter may be adjusted until the output of the receive chain falls below a third designated threshold amplitude. It will be appreciated that the third interference cancellation operations may also be performed dynamically and in response to interference signal detection after the second cancellation operations. For example, if an output of the receive chain continues to include interference exceeding the permissible threshold value after the second cancellation operations, the third interference cancellation operations may be performed.

Method 800 may perform operation 812 during which an output may be generated based on the first, second, and third interference cancellation operations. Accordingly, once the calibration phase is complete, the transceiver may return to radar operation. The receive chain may receive a radar signal, and may sequentially perform the first, second, and/or third interference cancellation operations at different stages of the receive chain. The result may be provided as an output representing the received signal.

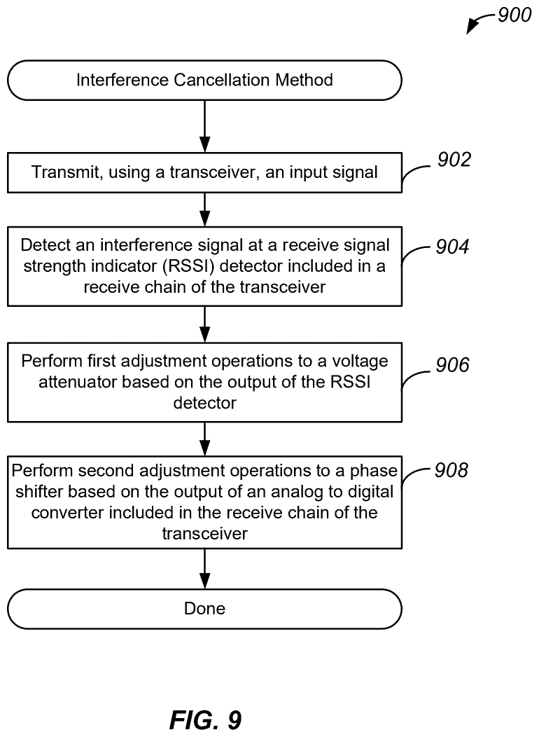

FIG. 9 illustrates an additional example of a method for interference cancellation, performed in accordance with some embodiments. As will be discussed in greater detail below, a method, such as method 900, may be performed to perform calibration operations for various components, such as a volage attenuator and a phase shifter. In this way, an initial stage of interference cancellation may be performed.

Method 900 may perform operation 902 during which an input signal may be transmitted using a transceiver. In various embodiments, the input signal is a designated signal, such as a training signal, generated and transmitted via a transmit chain of a transceiver during a calibration phase. Accordingly, the training signal may have a known data pattern as well as one or more transmission parameters configured to emulate signals used during radar detection operations.

Method 900 may perform operation 904 during which an interference signal may be detected at an RSSI detector included in a receive chain of the transceiver. Accordingly, the RSSI detector may detect a signal received at the receive chain, and the signal may be interference resulting from transmission activity on the transmit chain. Moreover, the RSSI detector may convert the detected signal, which may be detected at an output of an LNA included in the receive chain, to one or more discrete voltage levels based on an amplitude of the detected interference signal.

Method 900 may perform operation 906 during which first adjustment operations may be performed for a voltage attenuator based on the output of the RSSI detector. Accordingly the output of the RSSI detector may be provided as an input to the voltage attenuator, and may be configured to cause the voltage attenuator to implement a voltage offset based on the received input. As similarly discussed above, a designated mapping that may be stored in a look-up-table may be used to map an RSSI detector output value to a voltage offset applied by the voltage attenuator. In various embodiments, a search or other suitable algorithm, such as a steepest descent algorithm, is used to identify a voltage and phase adjustment that result in the smallest RSSI value.

Method 900 may perform operation 908 during which second adjustment operations may be performed for a phase shifter based on an output of an ADC included in the receive chain of the transceiver. Accordingly, an output of the receive chain may be sampled at an output of the ADC, and the output may be provided as an input to the phase shifter. As similarly discussed above, such adjustments to the phase shifter may be made based, at least in part, on a mapping that was determined based on an exhaustive search or a steepest descent algorithm.

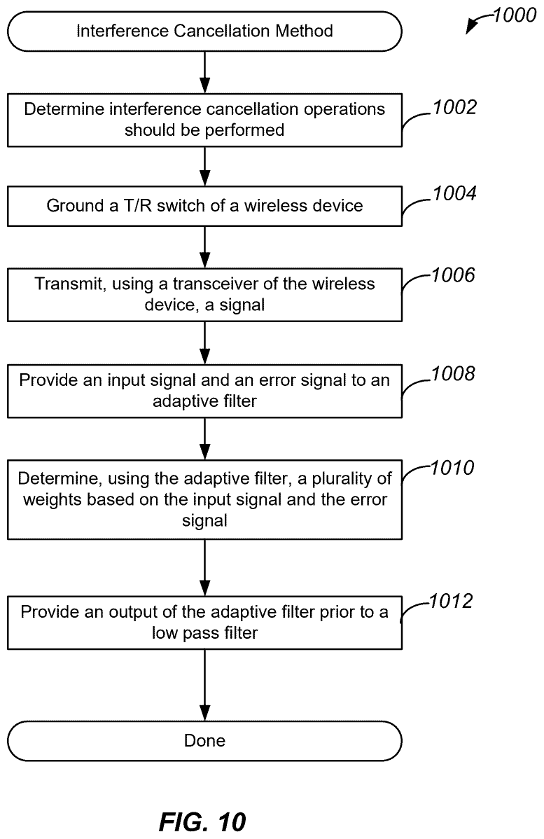

FIG. 10 illustrates another example of a method for interference cancellation, performed in accordance with some embodiments. As will be discussed in greater detail below, a method, such as method 1000, may perform additional calibration operations for various components, such as an adaptive filter. In this way, an additional stage of interference cancellation may be performed.

Method 1000 may perform operation 1002 during which it may be determined that interference cancellation operations should be performed. As similarly discussed above, such a determination may be made dynamically and in response to interference signal detection. For example, such interference signal detection may occur after initial interference cancellation operations, and based on an output of a receive chain exceeding a permissible threshold value. In this way, an additional stage of interference cancellation may be implemented dynamically.

Method 1000 may perform operation 1004 during which a transmit/receive (T/R) switch of a wireless device may be grounded. Accordingly, as similarly discussed above with reference to FIG. 2, a T/R switch may be configured to manage coupling between a transmit chain, a receive chain, and an antenna. In various embodiments, the T/R switch may also be configured to be coupled to a circuit ground. When coupled to ground, the input to the receive chain may emulate no signal being received, as may be the case when there is no object present within range of radar detection operations. Accordingly, grounding the T/R switch emulates a condition of no reflected signal being received, even if there is a nearby reflective object within range. Configuring the T/R switch in this way to nullify signals received via the antenna facilitates accurate identification and mitigation of interference from other sources, such as leakage.

Method 1000 may perform operation 1006 during which a signal may be transmitted using a transceiver of the wireless device. As similarly discussed above, the signal is a designated signal, such as a training signal, generated and transmitted via a transmit chain of a transceiver during the calibration phase. Accordingly, the training signal may have a known data pattern as well as one or more transmission parameters configured to emulate signals used during radar detection operations.

Method 1000 may perform operation 1008 during which an input signal and an error signal may be provided to an adaptive filter. In various embodiments, the input signal is the signal transmitted during operation 1006. Accordingly, an input to a DAC of the transmit chain may also be provided as an input to the adaptive filter. Moreover, an output of an ADC of the receive chain may also be provided to the adaptive filter as an error signal.

Method 1000 may perform operation 1010 during which a plurality of weights may be determined based on the input signal and the error signal. Accordingly, as similarly discussed above with reference to FIG. 4, one or more weights configured to control an operation of the adaptive filter may be adjusted until the weights converge such that an amplitude of the error signal falls below a permissible threshold value.

Method 1000 may perform operation 1012 during which an output of the adaptive filter may be provided prior to a low pass filter. As similarly discussed above, the output of the adaptive filter may be coupled prior to an LPF included in a receive chain of the transceiver. Accordingly, during radar operations, the adaptive filter may perform interference cancellation operations based on the plurality of weights, and prior to the LPF.

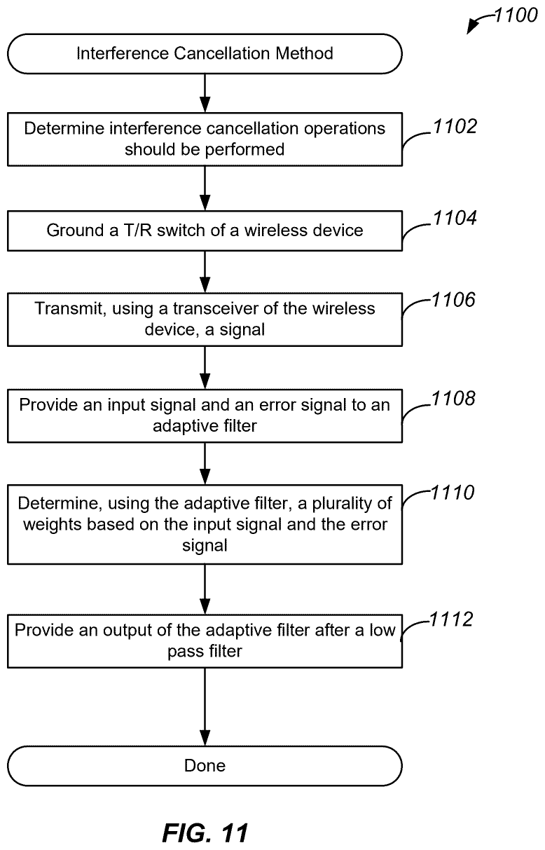

FIG. 11 illustrates an additional example of a method for interference cancellation, performed in accordance with some embodiments. As will be discussed in greater detail below, a method, such as method 1100, may perform additional calibration operations for various components, such as an additional adaptive filter. In this way, an additional stage of interference cancellation may be performed.

Method 1100 may perform operation 1102 during which it may be determined that interference cancellation operations should be performed. As similarly discussed above, such a determination may be made dynamically and in response to interference signal detection. For example, interference signal detection may occur after additional interference cancellation operations, and based on an output of a receive chain exceeding a permissible threshold value. In this way, a further stage of interference cancellation may be implemented dynamically and downstream of a component, such as an LPF.

Method 1100 may perform operation 1104 during which a T/R switch of a wireless device may be grounded. As similarly discussed above, the T/R switch may be grounded to emulate no signal being received, as may be the case when there is no object present within range of radar detection operations. Configuring the T/R switch in this way to nullify signals received via the antenna facilitates accurate identification and mitigation of interference from other sources, such as leakage.

Method 1100 may perform operation 1106 during which a signal may be transmitted using a transceiver of the wireless device. As similarly discussed above, the signal is a designated signal, such as a training signal, generated and transmitted via a transmit chain of a transceiver during the calibration phase. Accordingly, the training signal may have a known data pattern as well as one or more transmission parameters configured to emulate signals used during radar detection operations.

Method 1100 may perform operation 1108 during which an input signal and an error signal may be provided to an adaptive filter. In various embodiments, the input signal is the signal transmitted during operation 1106. Accordingly, an input to a DAC of the transmit chain may also be provided as an input to the adaptive filter. Moreover, an output of an ADC of the receive chain may also be provided to the adaptive filter as an error signal.

Method 1100 may perform operation 1110 during which a plurality of weights may be determined based on the input signal and the error signal. Accordingly, as similarly discussed above with reference to FIG. 5, one or more weights configured to control an operation of the adaptive filter may be adjusted until the weights converge such that an amplitude of the error signal falls below a permissible threshold value.

Method 1100 may perform operation 1112 during which an output of the adaptive filter may be provided after a low pass filter. As similarly discussed above, the output of the adaptive filter may be coupled after an LPF included in a receive chain of the transceiver. Accordingly, during radar operations, the adaptive filter may perform interference cancellation operations based on the plurality of weights, and after the LPF to further mitigate signal interference after the LPF. In this way, multiple stages of interference cancellation may be implemented to achieve precise and effective mitigation of interference that may arise from leakage.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
transmitting an input signal using a transmitter of a transceiver included in a wireless device;
receiving an interference signal at a receiver of the transceiver, wherein the interference signal is a leakage signal;
performing interference cancellation operations on the interference signal based, at least in part, on one or more adjustments to the receiver determined based on the input signal and the received interference signal; and
generating, using the transceiver, an output signal based, at least in part, on the interference cancellation operations.

2. The method of claim 1, wherein the performing of the interference cancellation operations further comprises:
detecting, using a receive signal strength indicator (RSSI) detector, the interference signal;
adjusting a voltage attenuator based, at least in part, on an output of the RSSI detector; and
adjusting a phase shifter based, at least in part, on an output the receiver.

3. The method of claim 2, wherein the voltage attenuator and phase shifter are coupled between the transmitter and receiver of the transceiver.

4. The method of claim 1, wherein the performing of the interference cancellation operations further comprises:
adjusting a first adaptive filter based, at least in part, on the input signal and an output the receiver.

5. The method of claim 4, wherein an output of the first adaptive filter is provided to the receiver prior to a low pass filter included in the receiver.

6. The method of claim 5, wherein the performing of the interference cancellation operations further comprises:
adjusting a second adaptive filter based, at least in part, on the input signal and an output the receiver.

7. The method of claim 6, wherein an output of the second adaptive filter is provided to the receiver after the low pass filter included in the receiver.

8. The method of claim 6, wherein the first adaptive filter and the second adaptive filter each comprise a least mean squares filter.

9. The method of claim 1, wherein the transceiver is compatible with a wireless communications protocol, and wherein the transceiver is operating in a radar mode.

10. A system comprising:
an antenna configured to transmit and receive wireless signals;
a processing device comprising one or more processors configured to generate an input signal;
a transceiver comprising a transmitter configured to:
transmit the input signal received from the processing device;
the transceiver further comprising a receiver configured to:
receive an interference signal, wherein the interference signal is a leakage signal;
perform interference cancellation operations on the interference signal based, at least in part, on one or more adjustments determined based on the input signal and the received interference signal;
generate an output signal based, at least in part, on the interference cancellation operations; and
a switch configured to couple the transceiver to the antenna.

11. The system of claim 10 further comprising:
a receive signal strength indicator (RSSI) detector configured to detect the interference signal;
a voltage attenuator configured to be adjusted based, at least in part, on an output of the RSSI detector; and
a phase shifter configured to be adjusted based, at least in part, on an output the receiver.

12. The system of claim 11, wherein the voltage attenuator and phase shifter are coupled between the transmitter and receiver of the transceiver.

13. The system of claim 10 further comprising:
a first adaptive filter configured to be adjusted based, at least in part, on the input signal and the output signal generated by the receiver.

14. The system of claim 13, wherein an output of the first adaptive filter is provided to the receiver prior to a low pass filter included in the receiver.

15. The system of claim 14, further comprising:
a second adaptive filter configured to be adjusted based, at least in part, on the input signal and the output signal generated by the receiver, wherein an output of the second adaptive filter is provided to the receiver after the low pass filter included in the receiver.

16. A device comprising:
one or more processors configured to generate an input signal; and
a transceiver comprising:
a transmitter configured to transmit the input signal;
a receiver configured to:
receive an interference signal, wherein the interference signal is a leakage signal;
perform interference cancellation operations on the interference signal based, at least in part, on one or more adjustments determined based on the input signal and the received interference signal; and
generate an output signal based, at least in part, on the interference cancellation operations.

17. The device of claim 16 further comprising:
a receive signal strength indicator (RSSI) detector configured to detect the interference signal;
a voltage attenuator configured to be adjusted based, at least in part, on an output of the RSSI detector; and
a phase shifter configured to be adjusted based, at least in part, on an output the receiver.

18. The device of claim 17, wherein the voltage attenuator and phase shifter are coupled between the transmitter and receiver of the transceiver.

19. The device of claim 16 further comprising:
a first adaptive filter configured to be adjusted based, at least in part, on the input signal and the output signal generated by the receiver, wherein an output of the first adaptive filter is provided to the receiver prior to a low pass filter included in the receiver.

20. The device of claim 19, further comprising:
a second adaptive filter configured to be adjusted based, at least in part, on the input signal and the output signal generated by the receiver, wherein an output of the second adaptive filter is provided to the receiver after the low pass filter included in the receiver.
